(19) United States
(12) Patent Application Publication
(10) Pub. No.: US 2022/0252223 A1
(43) Pub. Date: Aug. 11, 2022

(54) DEVICE FOR MEASURING RESIDUAL AMOUNTS IN HIGH-PRESSURE CONTAINER IN WHICH LIQUEFIED GAS IS STORED, AND HIGH-PRESSURE CONTAINER MANAGEMENT SYSTEM IN WHICH SAME IS MOUNTED

(71) Applicant: NICE EN TECH CO., LTD., Hwaseong (KR)

(72) Inventor: Yong Pil LEE, Seongnam (KR)

(21) Appl. No.: 17/614,287

(22) PCT Filed: Apr. 2, 2020
(86) PCT No.: PCT/KR2020/004494

§ 371 Date: Nov. 24, 2021

(30) Foreign Application Priority Data
Oct. 30, 2019 (KR) 10-2019-0136185

(51) Int. Cl. F17C 13/02; G01F 22/00

(52) U.S. Cl. CPC F17C 13/026; G01F 22/00; F17C 2223/035; F17C 2223/0153; F17C 2250/034; F17C 2205/0134; F17C 2250/0417; F17C 2201/0109; F17C 2250/0439

(57) ABSTRACT

The present invention relates to a residual quantity measuring device for a high pressure container storing liquefied gas and a management system for a high pressure container.

### TECHNICAL FIELD

The present invention relates to a residual quantity measuring device for a high pressure container storing liquefied gas and a management system for a high pressure container, and more particularly, to a residual quantity measuring device for a high pressure container storing liquefied gas and a management system for a high pressure container, in which, to monitor normal operations of a temperature sensor part and an LED display part, in a heat dissipation process of supplying electricity to the heating wire to monitor normal operations of the temperature sensor part and the LED display part and interrupting the electricity again, the temperature sensor part and the LED display part may be monitored more accurately in the same heat dissipation condition by eliminating a heat dissipation temperature deviation generated between a heating wire starting portion that is adjacent to the power supply part and a heating wire ending portion, and states of the high pressure containers storing the liquefied gas may be monitored in a central control center.

### BACKGROUND ART

In general, fire extinguishers for firefighting are classified into powder extinguishers, gas extinguishers, and foamite extinguishers according to kinds of used fire extinguishing chemicals, and a gas extinguisher widely used for large-scale fires, such as oil fires or electric fires, is mainly used as an extinguisher for equipment that uses liquefied gas as fire extinguishing chemicals and is used while on one gas container is not used independently but a plurality of gas containers are connected to each other (see FIG. 1), target buildings, in which the gas extinguishers have to be installed, such as an apartment machine room, a hospital generator room, a transformer room and a machine room of a large building, a computer room, a large factory, a telephone company, a subway station, as well as a ship, are ruled in the laws, and the gas extinguisher is ruled to be checked one to three times per year by the Fire Service Act and the High-Pressure Gas Safety Control Act.

However, because it is impossible to identify an amount of high-pressure liquefied gas stored in a gas container of the gas extinguisher by naked eyes, a method of measuring a weight of the gas container by using a scale is mainly used as a measurement method currently, but it is difficult to manually carry the gas container of a weight of about 180 kg and measure the weight because the gas container furnished in a ship or a building for firefighting is mainly equipped in a machine room and the like and thus transportation equipment cannot be used, and because the firefighting system has to be stopped to measure the weights of several hundreds of individual containers connected to the system, it violates the Fire Service Act to temporarily stop the system for measurement and the gas container cannot achieve the function of the firefighting equipment at all when a fire occurs during the measurement.

To solve the conventional problem, Korean Patent Application Publication No. 10-2013-0141845 (published on Dec. 17, 2013) suggested a residual quantity measuring device for a high pressure container storing liquefied gas and a management system for a high pressure container employing the same.

In the residual quantity measuring device for a high pressure container storing liquefied gas, as illustrated in FIG. 1, a body 21 that is a plate is attached to an outer wall surface of a gas container 10, an LED display part 24 is formed on a front surface of the body 21 that is the plate, a temperature sensor part 25 is provided on a rear surface of the body 21 that is the plate, a permanent magnet 23 is provided at an upper end and a lower end of a rear surface of the body 21 that is the plate such that the body 21 that is the plate is attached to the outer wall surface of the gas container 10 by the permanent magnet 23, and the body 21 that is the plate includes a power input part 22.

In the LED display part 24, a plurality of LED elements 24a are disposed between upper and lower sides of the body 21 of the measuring device at an equal interval to visually show a liquid surface of the liquefied gas through turning-on/off of the LED elements 24a, and the temperature sensor part 25 includes a plurality of heat sensors 25a corresponding to the locations and the number of the plurality of LED elements 24a on a rear surface of the body 21 that is the plate.

The above-configured conventional residual quantity measuring device for a high pressure container storing liquefied gas allows the residual quantity of the liquefied gas in the interior of the gas container 10 to be identified by naked eyes by comparing and analyzing detection signals delivered from the heat sensors 25 with a microprocessor and turning on and displaying the LED elements 24a corresponding to a border of a gas portion and a liquid portion, a temperature of which abruptly decreases as a result.

Meanwhile, the body 21 that is the plate further includes a heating wire 26 that is adjacent to the temperature sensor part 25, and the heating wire 26 is used to test whether the temperature sensor part 25 and the LED display part 24 are normally operated while firefighting equipment is checked. Furthermore, the body 21 that is the plate includes a check switch for supplying and interrupting electricity to and from the heating wire 26.

When the heating wire 26 emits heat by the electricity supplied by pushing a switch during the check, the heat sensor 25a detects the heat and sends a detection signal to the microprocessor, and the microprocessor turns on all of the LED elements 24a. Then, heat dissipation temperatures of the gas portion and the liquid portion become different while the heating wire 26 is cooled when the electricity to the heating wire 26 is interrupted, and the microprocessor in turn identifies a normal operation by comparing and analyzing detection signals delivered from the heat sensors and turning on the LED elements 24a corresponding to the border of the gas portion and the liquid portion.

However, in the conventional heating wire, a temperature deviation occurs between a starting portion and an ending portion of the heating wire that is adjacent to a power supply part, to which electricity is supplied. That is, as the heating wire is closer to the power supply part, the temperature of the heating wire is higher, and as the heating wire is more distant from the power supply part, the temperature of the heating wire is lower. When the heating wire is cooled as the supply of the electricity is interrupted, the temperature deviation makes it impossible to accurately check the temperature sensor part and the LED display part by determining a difference of the temperatures of the gas portion and the liquid portion under the same heat dissipation condition, and thus the reliability of the check deteriorates.

Furthermore, hundreds of gas containers that are kept and managed are connected to the system according to a size of a ship or a building, but a manager has to directly identify and check the gas containers because it is impossible to monitor the gas containers in a disaster prevention center, and thus inconvenience and inefficiency of the management and the operation are caused.

### Prior Technical Documents

(Patent document 1) 1. Korean Patent Application Publication No. 10-2013-0141845 (published on Dec. 17, 2013)

### DETAILED DESCRIPTION OF THE INVENTION

### Technical Problem

Accordingly, the present invention has been made in an effort to solve the above-mentioned problems, and provides a residual quantity measuring device for a high pressure container storing liquefied gas and a management system for a high pressure container, in which, to monitor normal operations of a temperature sensor part and an LED display part, in a heat dissipation process of supplying electricity to the heating wire to monitor normal operations of the temperature sensor part and the LED display part and interrupting the electricity again, the temperature sensor part and the LED display part may be monitored more accurately in the same heat dissipation condition by eliminating a heat dissipation temperature deviation generated between a heating wire starting portion that is adjacent to the power supply part and a heating wire ending portion, and states of the high pressure containers storing the liquefied gas may be monitored in a central control center.

### Technical Solution

An embodiment of the present invention provides a residual quantity measuring device for a high pressure container storing liquefied gas, in which a body that is a plate is attached to an outer wall surface of a gas container, an LED display part, in which a plurality of LED elements are disposed at an equal interval, is provided on a front surface of the body that is the plate, a temperature sensor part having a plurality of heat sensors) in correspondence of the LED elements is provided on a rear surface of the body that is the plate, the body that is the plate has a power supply part and a heating wire, permanent magnets are provided at upper and lower portions of a rear surface of the body that is the plate, and a check switch that supplies and interrupts electricity is provided in the heating wire, wherein the heating wire further includes a pattern vertically connected to a heating wire starting portion and a heating wire ending portion between the heating wire starting portion and the heating wire ending portion at an interval, and that reduces a temperature deviation generated between the heating wire starting portion and the heating wire ending portion in a heat dissipation process of the heating wire by outputting an average value of resistance temperatures according to applied quantities of electricity.

Furthermore, the pattern is formed such that downward vertical lines that form line forms toward a vertically lower side and upward vertical lines, a length of which is the same as that of the downward vertical lines and form line forms toward a vertically upper side are repeatedly formed horizontally at the same interval, and the upward vertical lines and the downward vertical lines are connected by lower connection lines and upper connection lines having a “U” shape, which are alternately and repeatedly formed.

An embodiment of the present invention provides a management system for a high pressure container storing liquefied gas, ion which high-pressure gas containers are connected to each other and are preserved, and are intensely managed by a central control center (a disaster prevention center), wherein the management system is formed by connecting, by wire or wirelessly, the central control center (the disaster prevention center) and residual quantity measuring devices attached to outer walls of the gas containers, wherein, in each of the residual quantity measuring devices, a body that is a plate is attached to an outer wall surface of a gas container, an LED display part, in which a plurality of LED elements are disposed at an equal interval, is provided on a front surface of the body that is the plate, a temperature sensor part having a plurality of heat sensors in correspondence of the LED elements is provided on a rear surface of the body that is the plate, the body that is the plate has a power supply part and a heating wire, permanent magnets are provided at upper and lower portions of a rear surface of the body that is the plate, and a check switch that supplies and interrupts electricity is provided in the heating wire, and wherein the heating wire further includes a pattern vertically connected to a heating wire starting portion and a heating wire ending portion between the heating wire starting portion and the heating wire ending portion at an interval, and that outputs an average value of resistance temperatures according to applied quantities of electricity.

### Advantageous Effects of the Invention

In this way, the present invention provides A residual quantity measuring device for a high pressure container storing liquefied gas, in which a body that is a plate is attached to an outer wall surface of a gas container, an LED display part, in which a plurality of LED elements are disposed at an equal interval, is provided on a front surface of the body that is the plate, a temperature sensor part having a plurality of heat sensors in correspondence of the LED elements is provided on a rear surface of the body that is the plate, the body that is the plate has a power supply part and a heating wire, permanent magnets are provided at upper and lower portions of a rear surface of the body that is the plate, and a check switch that supplies and interrupts electricity is provided in the heating wire, wherein the heating wire further includes a pattern vertically connected to a heating wire starting portion and a heating wire ending portion between the heating wire starting portion and the heating wire ending portion at an interval, and configured to reduce a temperature deviation generated between the heating wire starting portion and the heating wire ending portion in a heat dissipation process of the heating wire by outputting an average value of resistance temperatures according to applied quantities of electricity, whereby in a heat dissipation process of supplying electricity to the heating wire to monitor normal operations of the temperature sensor part and the LED display part and interrupting the electricity again, the temperature sensor part and the LED display part may be monitored more accurately in the same heat dissipation condition by eliminating a heat dissipation temperature deviation generated between the heating wire starting portion that is adjacent to the power supply part and the heating wire ending portion, and an easiness and an efficiency of management and operation as well as a performance and a reliability of a device may be further enhanced because a charging state and a total amount of the gas kept and managed in the keeping unit may be monitored via the residual quantity measuring device attached to the gas container in the central control center (the disaster prevention center) through a communication module.

### DESCRIPTION OF THE DRAWINGS

FIG. 1 is a perspective view of a general gas container keeping unit.

FIG. 2 is a view illustrating a state of attachment of a conventional residual quantity measuring device to a gas container, and a front surface and a rear surface of the residual quantity measuring device.

FIG. 3 is a view illustrating a microprocessor embedded in the residual quantity measuring device of FIG. 2, and a connection relationship between an LED display part and a sensor part.

FIG. 4 is a view schematically illustrating a state of monitoring the gas container keeping unit of FIG. 1 by a central control center (a disaster prevention center).

FIG. 5 is a partially enlarged view illustrating a pattern applied to a heating wire of a residual quantity measuring device for a high pressure container storing liquefied gas according to the present invention.

FIG. 6 is a view illustrating a state, in which the pattern of FIG. 5 is formed in a heating wire in a form of a film.

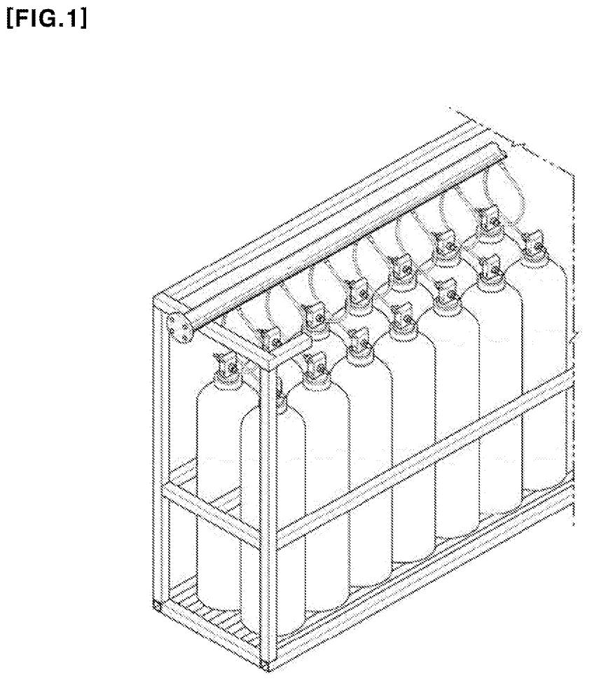

### BEST MODE

The above and other aspects, features, and advantages of embodiments of the present will become apparent from the following description of the following embodiments given in conjunction with the accompanying drawings.

However, the present invention is not limited by the embodiments disclosed herein but will be realized in various different forms, and the embodiments are provided only to make the disclosure of the present invention complete and fully inform the scope of the present invention to an ordinary person in the art, to which the present invention pertains, and the present invention will be defined by the scope of the claims. Throughout the specification, the same reference numerals denote the same elements.

In the following description of the present invention, a detailed description of known functions and configurations incorporated herein will be omitted when it may make the subject matter of the present invention rather unclear.

Furthermore, the following terms are those defined in consideration of functions in the embodiments of the present invention, and may become different according to an intention or customs of the operator. Therefore, the definition should be made based on the contents over the specification.

Hereinafter, configurations of a residual quantity measuring device for a high pressure container storing liquefied gas and a management system for a high pressure container employing the same according to the present invention will be described in detail according to embodiments with reference to the accompanying drawings.

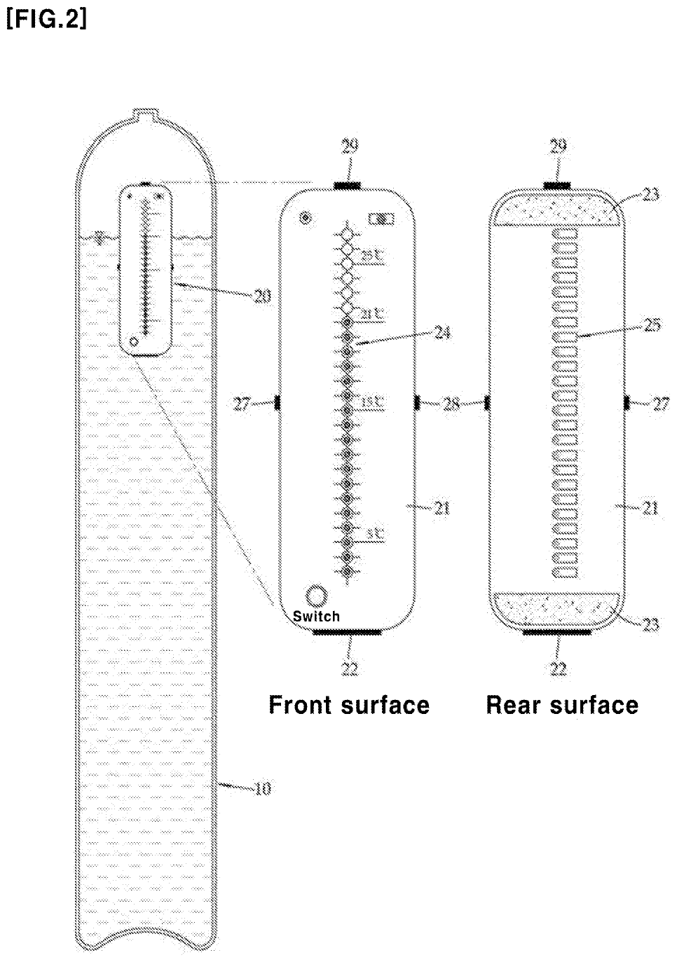

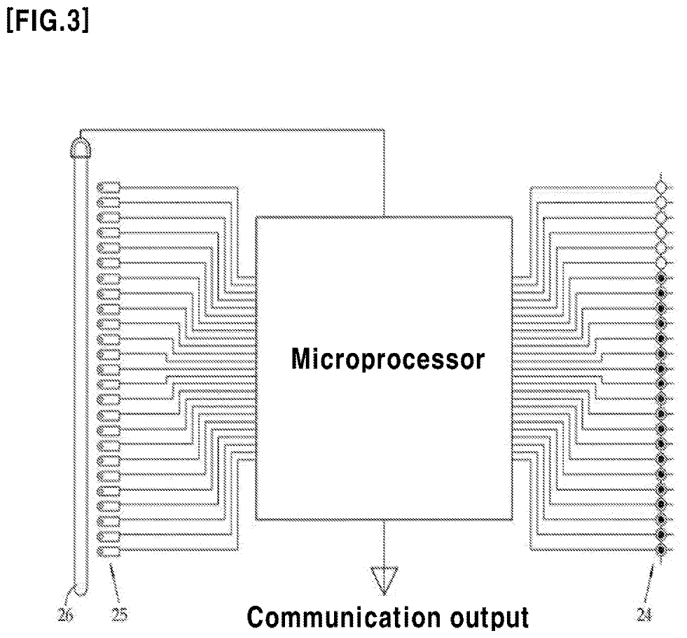

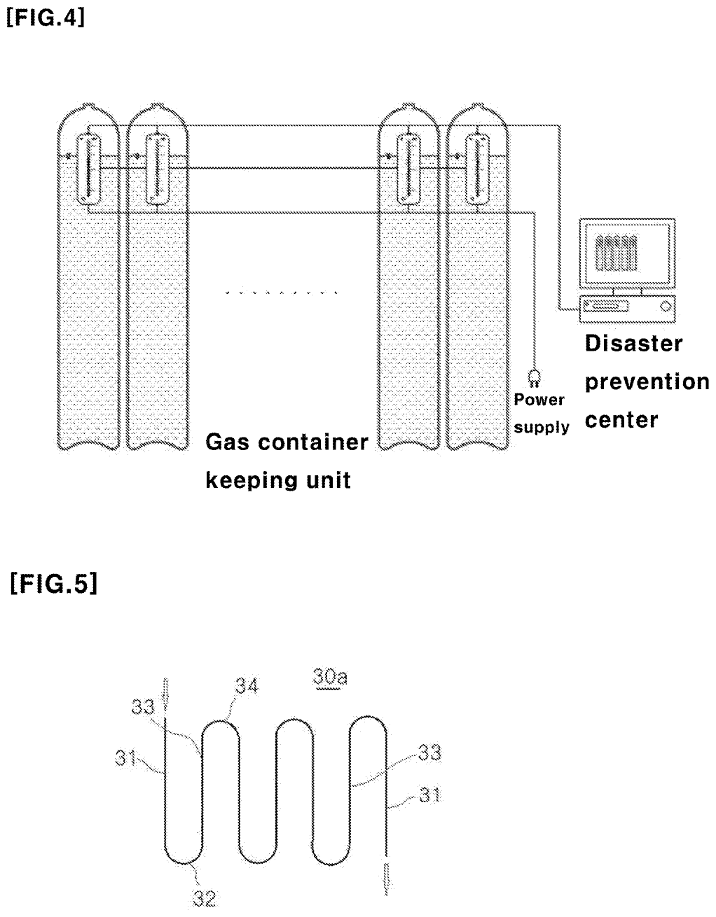

In a residual quantity measuring device for a high pressure container storing liquefied gas, as illustrated in FIGS. 2 and 3, a body 21 that is a plate is attached to an outer wall surface of a gas container 10, an LED display part 24, in which a plurality of LED elements are disposed at an equal interval, is provided on a front surface of the body 21 that is the plate, a temperature sensor part 25 having a plurality of heat sensors 25a in correspondence of the LED elements is provided on a rear surface of the body 21 that is the plate, the body 21 that is the plate has a power supply part 22 and a heating wire 30, permanent magnets 23 are provided at upper and lower portions of a rear surface of the body 21 that is the plate, and a check switch that supplies and interrupts electricity is provided in the heating wire 30.

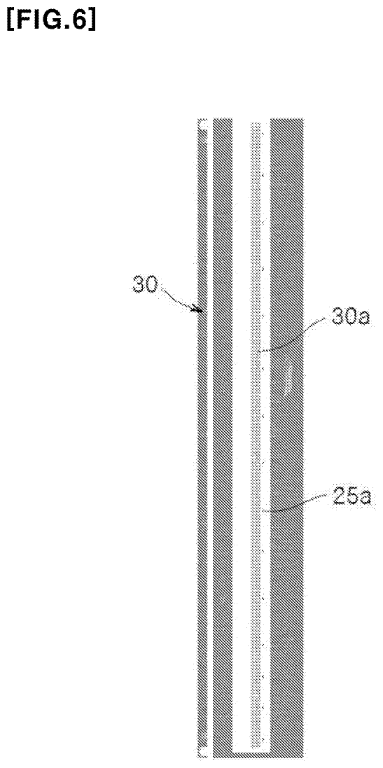

In the residual quantity measuring device for a high pressure container storing liquefied gas, according to the present invention, as illustrated in FIGS. 5 and 6, a pattern 30a that is vertically connected to a heating wire starting portion and a heating wire ending portion between the heating wire starting portion and the heating wire ending portion at an interval and outputs an average value of resistance temperatures according to applied quantities of electricity is formed.

The pattern 30a is formed such that downward vertical lines 31 that form line forms toward a vertically lower side and upward vertical lines 33, a length of which is the same as that of the downward vertical lines 31 and form line forms toward a vertically upper side are repeatedly formed horizontally at the same interval, and the upward vertical lines 33 and the downward vertical lines 31 are connected by lower connection lines 32 and upper connection lines 34 having a “U” shape, which are alternately and repeatedly formed.

The pattern 30a achieves temperature compensation for a high temperature and a low temperature that are adjacent and temperature compensation for a low temperature and a high temperature while the applied electricity repeatedly travels from the downward vertical lines 31 to the upward vertical lines 33 through the lower connection lines 32 and in turn travels from the upward vertical lines 33 to the downward vertical lines 31 through the upper connection lines 34.

Accordingly, the heating wire 30 dissipates heat when electric power is applied to the heating wire 30 by pushing the check switch and then the electric power supplied to the heating wire 30 is interrupted, and, then, the pattern 30a vertically connected to a heating wire starting portion and a heating wire ending portion between the heating wire starting portion and the heating wire ending portion at an interval may reduce a temperature deviation generated between the heating wire starting portion and the heating wire ending portion in a heat dissipation process of the heating wire 30 by outputting an average value of resistance temperatures according to applied quantities of electricity, and this means that the temperature sensor part 25 and the LED display part 24 may be monitored more accurately in the same heat dissipation condition of the heating wire 30.

Meanwhile, the body 21 that is the plate includes a start signal input terminal 27 and a start signal output terminal 28 connected to the gas container 10, and further includes a state signal output terminal 29 that transmits a charging state of the gas container 10 to a central control center (a disaster prevention center). The state information of the gas containers is transmitted while sequentially interworking with each other in a time division manner, whereby the state information of the gas containers connected to each other and kept in a preservation unit in unit of several hundred gas containers according to a size of a ship or a building may be prevented from being transmitted to the disaster prevention center at once and it is possible to monitor the states of the gas containers in the central control center (the disaster prevention center).

Furthermore, it is convenient because a power input part 22 that supplies necessary electric power to the body 21 that is the plate may use electric power of a battery as well as an external power source, and an amount of the liquefied gas stored in the gas container 10 may be measured while the battery is carried when the battery is used. The residual quantity measuring device 20 is connected to the central control center (the disaster prevention center) by wire or wirelessly, whereby the management system of the present invention intensively manages the central control center (the disaster prevention center).

Furthermore, the central control center (the disaster prevention center) is managed to receive an amount of the liquefied gas from a current measuring unit 20 attached to the gas container 10 and recognize an amount of the whole stored liquefied gas in the gas container kept and managed in a keeping unit, and is connected to an internet and managed and controlled to be monitored from an outside as well.

In this way, the present invention provides a residual quantity measuring device for a high pressure container storing liquefied gas, in which a body that is a plate is attached to an outer wall surface of a gas container, an LED display part, in which a plurality of LED elements are disposed at an equal interval, is provided on a front surface of the body that is the plate, a temperature sensor part having a plurality of heat sensors in correspondence of the LED elements is provided on a rear surface of the body that is the plate, the body that is the plate has a power supply part and a heating wire, permanent magnets are provided at upper and lower portions of a rear surface of the body that is the plate, and a check switch that supplies and interrupts electricity is provided in the heating wire, wherein the heating wire further includes a pattern vertically connected to a heating wire starting portion and a heating wire ending portion between the heating wire starting portion and the heating wire ending portion at an interval, and configured to reduce a temperature deviation generated between the heating wire starting portion and the heating wire ending portion in a heat dissipation process of the heating wire by outputting an average value of resistance temperatures according to applied quantities of electricity, whereby in a heat dissipation process of supplying electricity to the heating wire to monitor normal operations of the temperature sensor part and the LED display part and interrupting the electricity again, the temperature sensor part and the LED display part may be monitored more accurately in the same heat dissipation condition by eliminating a heat dissipation temperature deviation generated between the heating wire starting portion that is adjacent to the power supply part and the heating wire ending portion, and an easiness and an efficiency of management and operation as well as a performance and a reliability of a device may be further enhanced because a charging state and a total amount of the gas kept and managed in the keeping unit may be monitored via the residual quantity measuring device attached to the gas container in the central control center (the disaster prevention center) through a communication module.

Although the residual quantity measuring device for a high pressure container storing liquefied gas and the management system for a high pressure container employing the same according to the present invention have been described until now, those are simply most preferred embodiments of the present invention and do not limit the present invention, and the scope of the present invention is determined and limited by the attached claims. Furthermore, an ordinary person in the art, to which the present invention pertains, may variously modify and imitate the contents of the specification of the present invention, but the modifications and imitations will also fall within the scope of the present invention.

[Description of Reference Numerals]

10: gas container
20: residual quantity measuring device
21: body that is a plate
22: power input part
23: permanent magnet
24: LED display part
24a: LED element
25: temperature sensor part
25a: heat sensor
27: start signal input terminal
28: start signal output terminal
29: state signal output terminal
30: heating wire pattern
30a: pattern
31: downward vertical line lower connection line
32: lower connection line
33: upward vertical line
34: upper connection line

1. A residual quantity measuring device for a high pressure container storing liquefied gas, in which a body (21) that is a plate is attached to an outer wall surface of a gas container (10), an LED display part (24), in which a plurality of LED elements are disposed at an equal interval, is provided on a front surface of the body (21) that is the plate, a temperature sensor part (25) having a plurality of heat sensors (25a) in correspondence of the LED elements is provided on a rear surface of the body (21) that is the plate, the body (21) that is the plate has a power supply part (22) and a heating wire (30), permanent magnets (23) are provided at upper and lower portions of a rear surface of the body (21) that is the plate, and a check switch that supplies and interrupts electricity is provided in the heating wire (30), wherein the heating wire (30) further includes a pattern (30a) vertically connected to a heating wire starting portion and a heating wire ending portion between the heating wire starting portion and the heating wire ending portion at an interval, and configured to reduce a temperature deviation generated between the heating wire starting portion and the heating wire ending portion in a heat dissipation process of the heating wire (30) by outputting an average value of resistance temperatures according to applied quantities of electricity.

2. The residual quantity measuring device of claim 1, wherein the pattern (30a) is formed such that downward vertical lines (31) that form line forms toward a vertically lower side and upward vertical lines (33), a length of which is the same as that of the downward vertical lines (31) and form line forms toward a vertically upper side are repeatedly formed horizontally at the same interval, and the upward vertical lines (33) and the downward vertical lines (31) are connected by lower connection lines (32) and upper connection lines (34) having a “U” shape, which are alternately and repeatedly formed.

3. The residual quantity measuring device of claim 1, wherein the body (21) that is the plate further includes a start signal input terminal (27) and a start signal output terminal (28) connected to the gas container (10), and further includes a state signal output terminal that transmits a charging state of the gas container to a central control center (a disaster prevention center).

4. The residual quantity measuring device of claim 1, wherein a power source supplied to the body (21) that is the plate and the heating wire (30) is a battery.

5. A management system for a high pressure container storing liquefied gas, ion which high-pressure gas containers are connected to each other and are preserved, and are intensely managed by a central control center (a disaster prevention center), wherein the management system is formed by connecting, by wire or wirelessly, the central control center (the disaster prevention center) and residual quantity measuring devices attached to outer walls of the gas containers, wherein, in each of the residual quantity measuring devices, a body (21) that is a plate is attached to an outer wall surface of a gas container (10), an LED display part (24), in which a plurality of LED elements are disposed at an equal interval, is provided on a front surface of the body (21) that is the plate, a temperature sensor part (25) having a plurality of heat sensors (25a) in correspondence of the LED elements is provided on a rear surface of the body (21) that is the plate, the body (21) that is the plate has a power supply part (22) and a heating wire (30), permanent magnets (23) are provided at upper and lower portions of a rear surface of the body (21) that is the plate, and a check switch that supplies and interrupts electricity is provided in the heating wire (30), and wherein the heating wire (30) further includes a pattern (30a) vertically connected to a heating wire starting portion and a heating wire ending portion between the heating wire starting portion and the heating wire ending portion at an interval, and configured to output an average value of resistance temperatures according to applied quantities of electricity.
